(19) United States
(12) Patent Application Publication
(10) Pub. No.: US 2010/0083180 A1
(43) Pub. Date: Apr. 1, 2010

(54) Graphical User Interface Manipulation Method

(75) Inventors: Takashi Matsubara, Yokohama (JP); Yukinori Asada, Chigasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/491,410

(22) Filed: Jun. 25, 2009

(30) Foreign Application Priority Data
Sep. 29, 2008 (JP) 2008-249518

(51) Int. Cl. G06F 3/048

(52) U.S. Cl. 715/834

(57) ABSTRACT

An input apparatus includes an input unit via which a user can point specific coordinates on a screen, and a display unit for displaying a graphical user interface (GUI). A menu for selecting an arbitrary item from a plurality of items is displayed on the GUI. When the user conducts manipulation to move a location of coordinates pointed by the user on the screen so as to draw a circle, center coordinates of a circle locus of the manipulation are presumed regardless of the location of the coordinates. An item selected in the menu is moved so as to be associated with a rotation angle of the manipulation with respect to the center coordinates. The user can conduct selection manipulation of consecutive menu items without depending upon the location of coordinates pointed by the user on the screen.

### INCORPORATION BY REFERENCE

The present application claims priority from Japanese application JP2008-249518 filed on Sep. 29, 2008, the content of which is hereby incorporated by reference into this application.

### BACKGROUND OF THE INVENTION

The present invention relates to an input apparatus, an input system, a graphical user interface, and a graphical user interface manipulation method.

Personal computers and television sets which accept user's manipulation for a GUI (graphical user interface) via a remote controller and which give feedback of a manipulation result to a user by means of a dynamic change of the GUI are now spread.

Furthermore, a large number of devices having a configuration in which the GUI can be operated via the so-called pointing device such as a mouse and direct pointing using a free cursor is conducted on the GUI are spread.

In addition, a device having a function of recognizing a specific gesture from a locus of a free cursor and capable of conducting a specific manipulation by making a gesture begins to be put to practical use.

For example, JP-A-2003-348371 discloses a remote control apparatus and a manipulation control system including a manipulation panel for operating an electronic device, a display unit for displaying the manipulation panel, a track pad for inputting location information or contact information by contacting and moving it with a finger, an assigning unit for assigning the location information acquired by the track pad unit to an associated location on the manipulation panel, and a control unit for exercising manipulation control on the manipulation panel on the basis of the location information acquired by the track pad unit or the associated location information acquired by the assigning unit, wherein an associated location in the track pad unit is determined on the basis of a shape of the manipulation panel and the assigning unit is changed according to the contact information of the track pad unit.

Owing to the remote control apparatus and manipulation control system, it is possible to cause user's visual sense of focus moving on the manipulation panel to coincide with manipulation sense of track pad finger moving.

JP-A-2003-233452 discloses a gesture command input apparatus which recognizes a user who makes a gesture when converting the gesture input by using a part of a user's body or a dedicated order medium to a manipulation command for a device and converts the gesture input by the user to a command on the basis of a gesture command specific to the user previously registered every user.

Owing to this gesture command input apparatus, the user can input a command by using a gesture the user is accustomed to use and it becomes possible to recognize which user is inputting the gesture.

### SUMMARY OF THE INVENTION

Owing to the remote control apparatus or the manipulation control system according to JP-A-2003-348371, it becomes possible to cause user's visual sense of focus moving on the manipulation panel to coincide with manipulation sense of track pad finger moving, and an intuitive manipulation which is easier to use becomes possible.

In a method in which a user accurately points a location of a specific item such as a button to conduct manipulation as in the remote control apparatus and manipulation control system described in JP-A-2003-348371, the following problem is posed. Especially when operating a TV set or the like from a distant place by using a remote controller, the user needs to conduct location alignment with a fine manipulation at hand while paying attention to a menu displayed on the remote screen, resulting in a problem that user's fatigue caused by the manipulation is great.

The gesture command input apparatus described in JP-A-2003-233452 has a configuration which converts a gesture input by the user to a command on the basis of a gesture command specific to the user previously registered every user. As a result, the user can input a command by using a gesture the user is accustomed to use and it becomes possible to recognize which user is inputting the gesture.

However, the user needs to memorize gesture commands registered previously according to a device or software to be operated and recall the gesture commands at the time of actual inputting. This results in a problem of an increased user's memorization burden.

Furthermore, since the user determines gesture commands individually, relations between gesture commands and the GUI are not previously determined.

As a result, the user cannot receive real time feedback as to whether a gesture command to be input is effective, from the device or software of the manipulation subject. This results in a problem that the user cannot judge gesture commands which can be input at that time.

In addition, there is a desire for consecutive inputting in the manipulation of the device or software.

For example, it is desired that a volume adjustment button can be depressed consecutively, a channel changeover button can be depressed consecutively, and menu item selection can be conducted consecutively when operating a TV set.

However, making a manipulation of inputting consecutively by using a remote controller manipulation or a gesture command smooth is not described in JP-A-2003-348371 and JP-A-2003-233452.

The present invention has been made in view of these problems, and an object thereof is to provide an input apparatus which makes it unnecessary for the user to be conscious of the location on which the user conducts a manipulation, provides the user with real feedback concurrently with presenting effective input manipulations to the user, uses a simple calculation method reduced in processing load, and makes possible consecutive input manipulations.

An input apparatus according to the present invention includes an input unit via which a user can point specific coordinates on a screen, and a display unit for displaying a GUI. A selection item having a form which allows the user to select an arbitrary item from among a plurality of items and an image which indicates a manipulation state in accordance with user's manipulation are displayed on the GUI. When the user conducts a manipulation to move a location of coordinates pointed by the user on the screen so as to draw a circle, center coordinates of a circle locus of the manipulation are determined regardless of the location of the coordinates. The image which indicates the manipulation state is rotated in association with a rotation angle of the manipulation with respect to the center coordinates. In addition, when the image which indicates the manipulation state has rotated by a predetermined angle, an item selected in the selection item is moved. As a result, the manipulation state is presented to the user via the GUI. At the same time, the user can conduct selection manipulation of consecutive menu items without depending upon the location of coordinates pointed by the user on the screen and without needing the accuracy in user's manipulation.

In addition, the image which indicates the manipulation state in accordance with the user's manipulation has a shape which represents a rotation manipulation and a shape which represents the so-called handle for providing the shape which represents the rotation manipulation with a rotation. The handle is rotated so as to be associated in location with an angle formed by a location of coordinates pointed by the user on the screen and the center coordinates of the circle locus. As a result, the user can recognize the manipulation state easily.

When determining the center coordinates of the circle locus, an average location of coordinates pointed by the user on the screen over a definite time period may be regarded as the center coordinates, in order to make it possible to recognize the user's manipulation with computation processing which is light in load.

In addition, when determining the center coordinates of the circle locus, the center coordinates may be disposed in a place which is a predetermined distance from the average location of coordinates pointed by the user on the screen over a definite time period, provided that coordinates pointed by the user on the screen are located at the same coordinates over a definite time period. When the average location converges to a location of coordinates pointed on the screen by the user and the user resumes the manipulation of moving the location of coordinates pointed on the screen by the user so as to draw a circle, it prevents user's small rotation manipulation from being recognized as a large rotation manipulation and makes it possible for the user to start a manipulation smoothly.

When determining the center coordinates of the circle locus, coordinates pointed by the user on the screen may be acquired at intervals of a definite time period and a center of a circle which passes through coordinates of three latest points may be regarded as the center coordinates, in order to make it possible to recognize the user's manipulation with computation processing which is light in load.

In addition, if the center of the circle which passes through the coordinates of the three latest points is at least a definite distance from the calculated location of the center coordinates, then the center coordinates may not be replaced by coordinates of the center of the circle which passes through the coordinates of the three latest points. As a result, it is prevented that a user's manipulation is recognized as a rotation manipulation for center coordinates which are at least a definite distance and consequently a rotation cannot be input unless the user conducts a large rotation manipulation or even when the user is about to conduct a manipulation different from a rotation manipulation the manipulation is recognized as the rotation manipulation. Even if the user has temporarily and greatly diverted a locus which draws a circle without intention, or the user has conducted a manipulation without the intention of a circle manipulation, the user's manipulation is reflected to the GUI suitably.

According to the present invention, it becomes possible to provide an input apparatus and an input system which makes it unnecessary for the user to be conscious of the location on which the user conducts a manipulation, provides the user with real feedback concurrently with presenting effective input manipulations to the user, uses a simple calculation method reduced in processing load, and makes possible consecutive input manipulations.

Other objects, features and advantages of the invention will become apparent from the following description of the embodiments of the invention taken in conjunction with the accompanying drawings.

### BRIEF DESCRIPTION OF THE DRAWINGS

FIG. 1 is a general view diagram showing a configuration of screen display on an input apparatus according to a first embodiment and a second embodiment;

FIG. 2 is a block diagram showing a configuration of the input apparatus according to the first embodiment;

FIG. 3 is a diagram showing a manipulation method using a typical pointing device of a GUI in the first embodiment or the second embodiment;

FIG. 4 is a diagram showing a manipulation method of a user and operation of the GUI in the first embodiment;

FIG. 5 is a diagram showing a manipulation method of a user and operation of the GUI in the first embodiment;

FIG. 6 is a flow diagram for explaining operation of the input apparatus according to the first embodiment;

FIG. 7 is a diagram showing a manipulation method of a user and operation of the GUI in the second embodiment;

FIG. 8 is a diagram showing a manipulation method of a user and operation of the GUI in the second embodiment; and

FIG. 9 is a flow diagram for explaining operation of the input apparatus according to the second embodiment.

### DESCRIPTION OF THE EMBODIMENTS

Hereafter, embodiments of the present invention will be described.

### 1. First Embodiment

An input apparatus 200 according to the present embodiment is an apparatus which receives a user's input manipulation from a predetermined pointing device and which can change display of a GUI in response to the input manipulation.

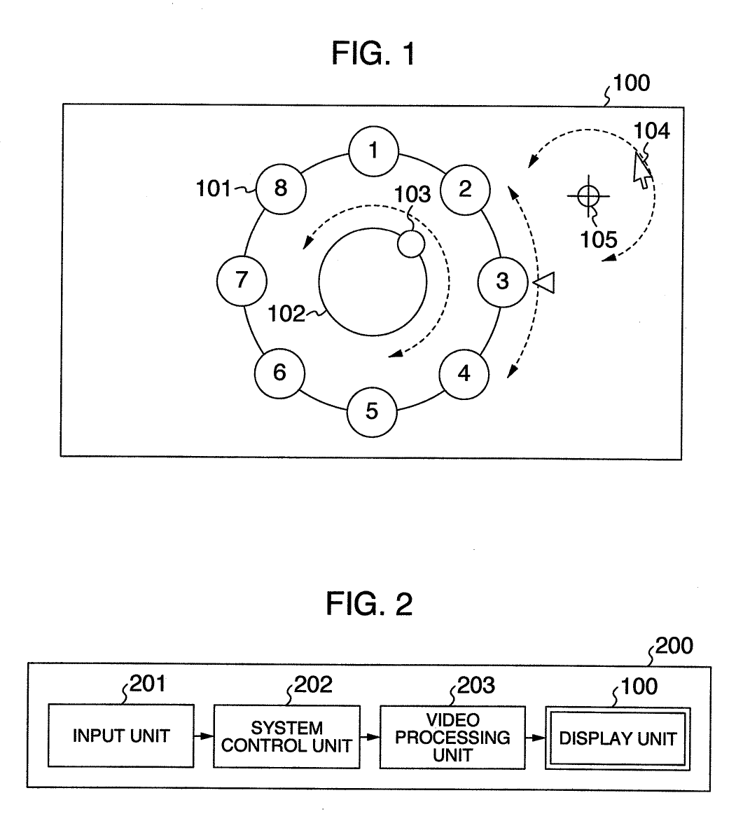

FIG. 1 shows a general view of the GUI used when the user manipulates the input apparatus 200 by using a display unit 100, a selection item 101, a wheel 102, a handle 103, a cursor 104, and a center 105 of a circle operation.

The display unit 100 is a display device in the input apparatus 200. For example, the display unit 100 is a display unit of a display device such as a liquid crystal display or a plasma display. The selection item 101, the wheel 102, the handle 103, and the cursor 104 are images displayed on the GUI. The selection item 101 is an item selected by the user via user's manipulation. The wheel 102 and the handle 103 are images for making it possible for the user to grasp a state of user's manipulation described later. The cursor 104 is an image displayed on a specific location of the display unit 100 pointed by the user via a pointing device which is not illustrated. The circle operation center 105 indicates a center location of a circle locus of the cursor 104 obtained when the user conducts manipulation to rotate the cursor 104 so as to draw a circle in the user's manipulation described later. As a matter of fact, the circle operation center 105 is not displayed on the display unit 100.

As shown in FIG. 2, the input apparatus includes an input unit 201, a system control unit 202, a video processing unit 203, and the display unit 100. The input unit 201 is formed of a pointing device or the like which is not illustrated. The input unit 201 outputs a manipulation direction, a manipulation distance, and coordinate information obtained as a result of user's manipulation of the pointing device.

The system control unit 202 is formed of, for example, a microprocessor. The system control unit 202 controls operation of the video processing unit 203 in response to a command received from the input unit 201. The video processing unit 203 is formed of, for example, a processing device such as an ASIC, FPGA or MPU. The video processing unit 203 converts video data of the GUI to a form which can be processed by the display unit 100 in accordance with control from the system control unit 202.

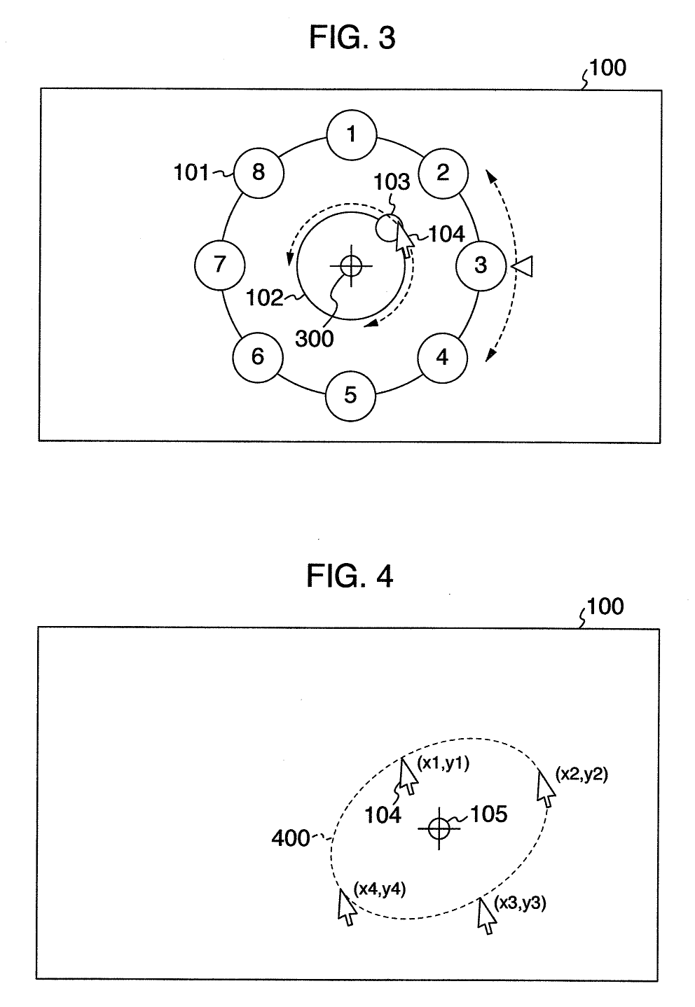

FIG. 3 shows an example in the case where the GUI shown in FIG. 1 is not manipulated by using a manipulation method according to the present invention described later, but manipulated by using a typical manipulation method using the free cursor. A center 300 indicates a center of the wheel 102. As a matter of fact, the center 300 is not displayed on the display unit 100.

The user conducts manipulation to rotate the wheel 102 by conducting manipulation to rotate the cursor 104 with the center 300 taken as a center of the rotation. This method is shown in FIG. 3. Furthermore, the handle 103 is disposed so as to correspond to an angle at which the cursor 104 is disposed with respect to the center 300.

FIG. 4 shows an example in which a location of the cursor 104 changes at regular intervals of time when the user manipulates the cursor 104. The cursor 104 is moved to a coordinate (x1,y1), a coordinate (x2,y2), a coordinate (x3,y3), and a coordinate (x4,y4) in the cited order at regular intervals of time. A result thereof is shown in FIG. 4.

A circle locus 400 on which the cursor is moved by user's manipulation. The circle locus passes through the four points described above. In FIG. 4, the circle operation center 105 indicates the center of the circle locus 400.

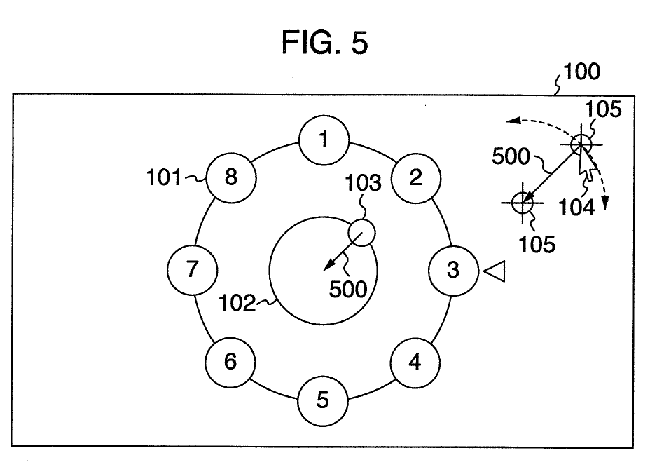

FIG. 5 shows an example of the state of the GUI obtained when the user temporarily stops manipulation of the cursor 104. In FIG. 5, the cursor 104 is at a standstill. A direction 500 is a direction headed from the handle 103 to the center of the wheel 102 in a state in which the user has stopped the manipulation. An example in which the circle operation center 105 is moved in the direction 500 according to a method described later is shown in an upper right-hand region of FIG. 5.

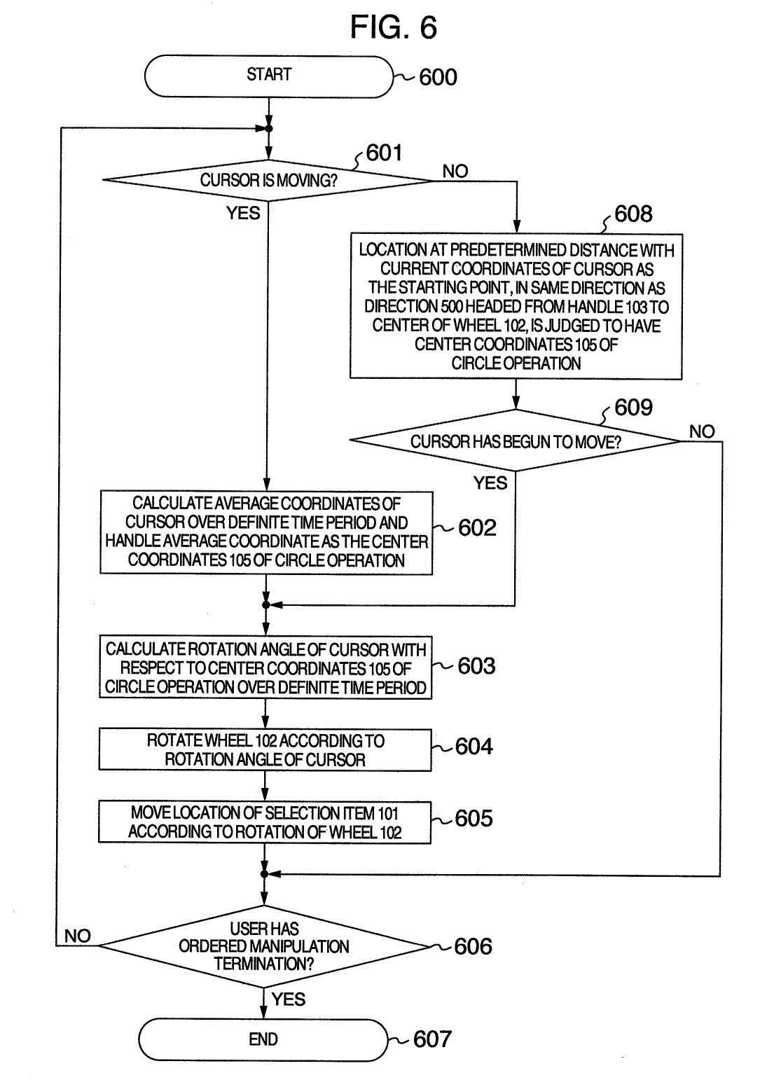

Operation of the input apparatus 200 having the above-described configuration will now be described with reference to FIGS. 1, 2, 3, 4, and 5 a flow chart in FIG. 6.

The input apparatus 200 is an apparatus receiving a user's input manipulation from a predetermined pointing device which is not illustrated and capable of changing display of the GUI in response to the input manipulation.

First, a manipulation method of the input apparatus 200 will now be described with reference to FIG. 1. The user can move the cursor 104 to a free location in the display unit 100 by using a predetermined pointing device which is not illustrated.

If the user conducts a manipulation to move the cursor 104 so as to draw a circle, then the wheel 102 and the handle 103 are rotated simultaneously around the center of the wheel 102. At this time, the location where the cursor 104 is rotated so as to draw a circle may be any location in the display unit 100. Without depending upon relative location relations between the location of the cursor 104 and the locations of the wheel 102 and the handle 103, therefore, the user can conduct a manipulation to rotate the cursor 104 so as to draw a circle in an arbitrary place.

In addition, if the wheel 102 and the handle 103 are rotated by a specific angle by the above-described manipulation, then the selection item 101 is rotated and moved so as to select the next item.

Owing to the series of operations, the user can select an arbitrary item in the selection item 101 by conducting the manipulation to move the cursor 104 so as to draw a circle.

By the way, the handle 103 rotates so as to cause an angle of the location of the cursor 104 with respect to the circle operation center 105 of the cursor 104 to become equal to an angle of the location of the handle 103 with respect to the center of the wheel.

If the wheel 102 and the handle 103 are rotated by a specific angle, then the selection item 101 is rotated and moved to select the next item. As a result, it becomes possible to provide the user's rotation manipulation with the so-called “play.”

In other words, the user can select a specific item included in the selection item 101 with a rough manipulation without caring about fine location alignment in the rotation manipulation.

The wheel 102 and the handle 103 rotate as occasion demands in synchronism with the user's manipulation. As a result, it becomes possible for the user to grasp the user's manipulation state. For example, also in the case where the cursor 104 is not actually displayed on the display unit 100, therefore, the user can conduct a manipulation smoothly.

In general, in the case where the user manipulates the GUI by using the so-called free cursor such as the cursor 104, the user conducts the manipulation by aligning the location of the cursor 104 with a location of a manipulation subject such as, for example, a button.

FIG. 3 is a diagram for explaining the case where the GUI shown in FIG. 1 is manipulated by using the typical free cursor manipulation method instead of the manipulation method of the input apparatus 200 described above.

When manipulating the GUI in the present embodiment, the user moves the cursor 104 to the location of the handle 103, and rotates the handle 103 and the wheel 102 by using a method of moving the location of the cursor 104 while maintaining the selection state, such as the so-called drag. If the method of maintaining the selection state such as the drag is not used, the user conducts a manipulation to rotate the wheel 104 by taking the center 300 of the wheel 102 as the center of the circle operation.

In this case, the manipulation depends upon the relative location relations between the location of the cursor 104 and the locations of the wheel 102 and the handle 103. Therefore, it is necessary for the user to align the location and manipulation of the cursor 104 with the center 300 of the handle 103 and the wheel 102 accurately. Therefore, the user cannot conduct a manipulation without caring about the fine location relation, unlike the manipulation method described earlier.

In such a case, the following problem is posed. Especially when conducting a manipulation on the display unit 100 located at a distance as in a TV set manipulated via a remote controller, the user's fatigue caused by the manipulation becomes great.

A flow of processing of changing the display of the GUI according to the user's input manipulation will now be described with reference to FIG. 2.

It is now supposed that the user has started operation of the input apparatus 200 by, for example, depressing a power supply button, which is not illustrated, on the input unit 201. The system control unit 202 orders the video processing unit 203 to display the GUI in response to start of the operation. The video processing unit 203 outputs a video signal suitable for the input of the display unit 100 in response to the order. As a result, the GUI is displayed on the display unit 100.

Furthermore, the system control unit 202 starts acceptance of user's input manipulation via the input unit 201 in response to the start of the operation. The input unit 201 accepts the user's input manipulation, and outputs a predetermined command to the system control unit 202. The system control unit 202 orders the video processing unit 203 to change the display of the GUI in response to contents of the received command. The video processing unit 203 changes data which forms the GUI in response to the order, and outputs a video signal suitable to the input of the display unit 100 based on the data. As a result, the GUI displayed on the display unit 100 is updated.

A method used by the input apparatus 200 to analyze the manipulation conducted by the user to move the cursor 104 so as to draw a circle will now be described with reference to FIGS. 4 and 5 and the flow chart shown in FIG. 6.

First, the user starts manipulation of the input apparatus 200 according to a predetermined procedure (step 600). Upon start of the manipulation, the input apparatus 200 begins to monitor the motion of the cursor 104 (step 601). If the cursor 104 is moving (Yes at the step 601), then the input apparatus 200 calculates average coordinates of coordinates over which the cursor 104 has moved over a definite time period. In addition, the input apparatus 200 supposed that the cursor 104 has moved as indicated by the circle locus 400 in FIG. 4, and handles the average coordinate as the center coordinates 105 of the circle operation (step 602). Subsequently, the input apparatus 200 calculates a rotation angle of the cursor 104 with respect to the center coordinates 105 over a definite time period (step 603). The wheel 102 is rotated according to the rotation angle (step 604). In addition, if the wheel 102 is rotated by a definite angle, then the selection item 101 is rotated and moved so as to select the next item in the selection item 101 (step 605). If the user orders manipulation termination by conducting a predetermined manipulation (Yes at step 606), then the input apparatus terminates the processing (step 607). If the user does not terminate the manipulations (No at the step 606), then similar processing is continued (the step 601). On the other hand, if the cursor 104 is not moving (No at the step 601), then a location at a predetermined distance with current coordinates of the cursor 104 as the starting point, in the same direction as the direction 500 headed from the handle 103 to the center of the wheel 102 is judged to have the center coordinates 105 of the circle operation (step 608). Details of the processing conducted at the step 608 will be described later. If subsequently the user starts a manipulation and the cursor begins to move (Yes at step 609), then the processing of the step 603 and subsequent steps is conducted according to the procedure described earlier. If the cursor 104 is not moving continuously (No at the step 609), then the processing at the step 606 and subsequent steps is conducted. The reason why the processing at the step 608 is conducted in the above-described procedure will now be described. If the cursor 104 is not moving, then the average coordinates of the cursor 104 converge to the current location of the cursor 104. Therefore, the center coordinates 105 of the circle operation become the same coordinates as the coordinates of the cursor 104.

When the user subsequently has begun to move the cursor 104, therefore, the input apparatus 200 recognizes a rotation manipulation along an infinitely small circle locus and a small movement of the cursor 104 rotates the wheel 102 greatly. This results in a problem that the user cannot start the manipulation as the user desires.

In order to solve this problem, therefore, the center coordinates 105 of the circle operation are separated from the coordinates of the cursor 104 by a predetermined distance when the cursor 104 is not moving.

The GUI according to the present invention has a configuration which reminds the user of the manipulation of holding the handle 103 and rotating the wheel 102 when the user conducts the circle manipulation. Utilizing the feature of this configuration, the angle of the handle 103 is associated with the angle of the cursor 104 with respect to the center coordinates 105, when the cursor 104 is not moving. When the user begins to move the cursor 104, the manipulation can be started smoothly by grasping an angle at which the circle operation should be started on the basis of the angle of the handle 103.

In this way, the input apparatus 200 can select an arbitrary item in the selection item 101 by conducting a manipulation via the input unit 201 formed of a pointing device or the like and thereby conducting the manipulation to move the cursor 104 so as to draw a circle.

No matter which coordinates on the display unit 100 the cursor 104 is located in, the user can conduct the above-described manipulation. And the input apparatus 200 implements the above-described manipulation by using a method which is light in the load of computation processing. According to this method, the input apparatus 200 calculates average coordinates of the cursor 104 and calculates the rotation angle of the cursor 104 on the basis of assumption that the average coordinates are the center coordinates 105 of the circle operation.

In addition, in order to solve the above-described problem that the cursor stops for a definite time and then begins to move again and consequently a small motion of the cursor 104 rotates the wheel 102 greatly, the input apparatus 200 moves the center coordinates 105 to the location described earlier provided that the motion of the cursor 104 has stopped for a definite time period.

As a result, the user can conduct manipulation intuitively in association with the display of the GUI. In addition, since the user receives real time feedback for the manipulation from the GUI, the user can understand the user's manipulation state easily.

Furthermore, since manipulations are conducted by using a circle motion, manipulations such as the menu item selection can be conducted continuously and smoothly.

### 2. Second Embodiment

A second embodiment will now be described. In the present embodiment, a recognition method different from the recognition method of user's manipulation described with reference to the input apparatus 200 in the first embodiment will be described. A configuration of the input apparatus 200 and a configuration of a GUI displayed on the display unit 100 are the same as those in the first embodiment. The second embodiment differs from the first embodiment only in the user's manipulation recognition method.

Hereafter, the present embodiment will be described with reference to the drawings. In the ensuing description, the same components as those in the first embodiment are denoted by like characters. Description thereof will be omitted in order to avoid duplication.

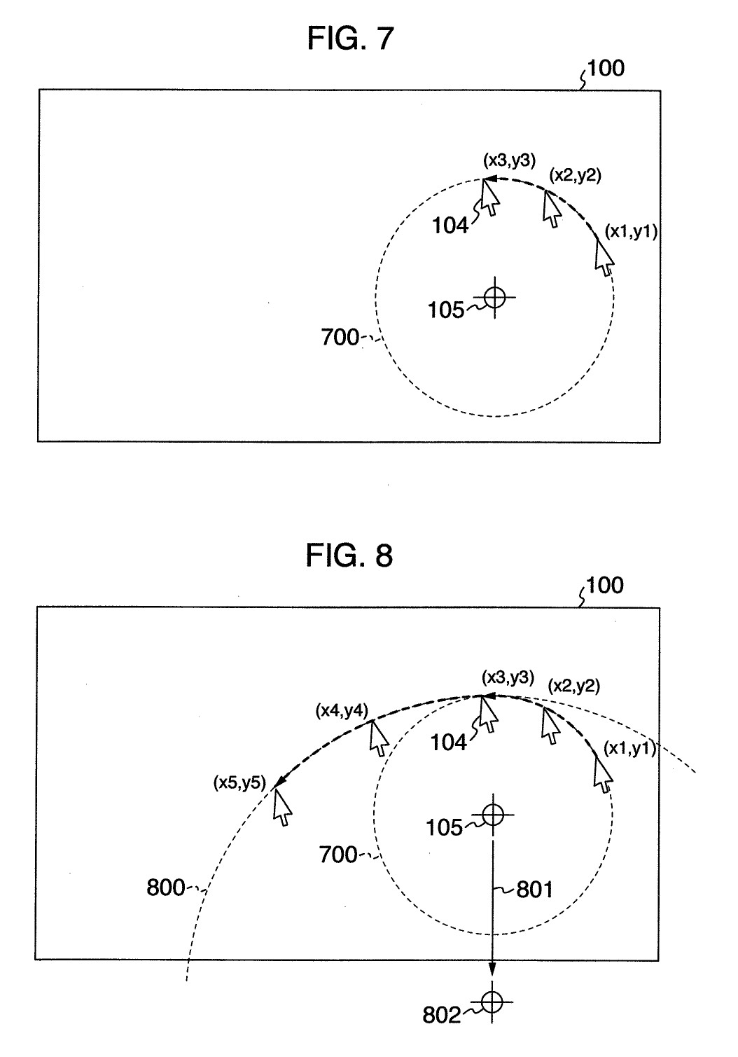

FIG. 7 shows an example in which the location of the cursor 104 changes at intervals of a definite time period when the user has manipulated the cursor 104. A result of movement of the cursor 104 to coordinates (x1,y1), coordinates (x2,y2) and then coordinates (x3,y3) in the cited order at intervals of a definite time period is shown in FIG. 7. A circle locus 700 indicates a circle locus passing through the coordinates of the above-described three points which can be presumed by using a method described later. The circle operation center 105 indicates a center of the circle locus 700.

FIG. 8 shows a result of movement of the cursor 104 to coordinates (x3,y3), coordinates (x4,y4) and then coordinates (x5,y5) in the cited order at intervals of a definite time period subsequently to the user's manipulation shown in FIG. 7. A circle locus 800 indicates a circle locus passing through the coordinates of the above-described three points which can be presumed by using a method described later.

Center coordinates 802 indicate a center of the circle locus 800. A direction in which the circle operation center 105 described with reference to FIG. 7 moves to a place of the central coordinates 802 in FIG. 8 is indicated by a direction 801.

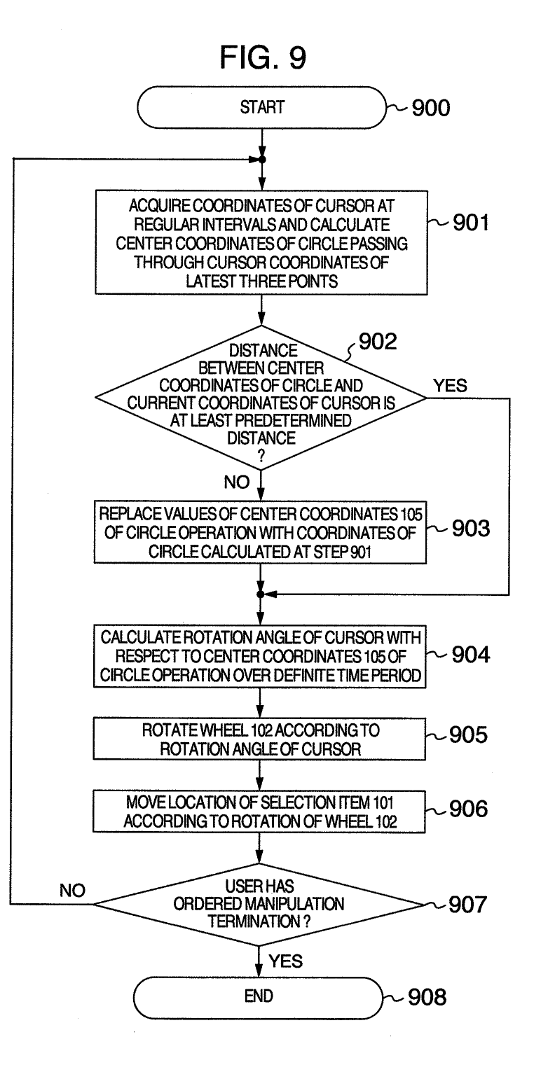

Hereafter, operation of the present embodiment will be described with reference to FIGS. 7 and 8 and a flow chart shown in FIG. 9.

First, the user starts manipulation of the input apparatus 200 in accordance with a predetermined procedure (step 900). Upon start of the manipulation, the input apparatus 200 begins to monitor the motion of the cursor 104 and acquires coordinates of the cursor at intervals of a definite time period. In addition, the input apparatus 200 calculates center coordinates (Xc,Yc) of a circle passing through coordinates of the latest three points on which the cursor 104 has moved, on the basis of the following equations (step 901).

G=y2*x1−y1*x2+y3*x2−y2*x3+y1*x3−y3*x1

Xc={(x1²+y1²)*(y2−y3)+(x2²+y2²)*(y3−y1)+(x3²+y3²)*(y1−y2)}/(2*G)

Yc=−{(x1²+y1²)*(x2−x3)+(x2²+y2²)*(x3−x1)+(x3²+y3²)*(x1−x2)}/(2*G)

Subsequently, the input apparatus 200 calculates a distance between the center coordinates (Xc,Yc) of the circle and current coordinates of the cursor 104. If the distance is less than a predetermined distance (No at step 902), then the input apparatus 200 supposes that the cursor 104 continues to move along the circle locus 700 shown in FIG. 7, and handles the center coordinates (Xc,Yc) as the center coordinates 105 of the circle operation (step 903). On the other hand, if the distance is equal to at least the predetermined distance (Yes at the step 902), then the processing at the step 903 is not conducted and the values of the center coordinates 105 of the circle operation already held are held continuously. By the way, details of the processing conducted when the decision at the step 902 is “Yes” will be described later. Subsequently, the input apparatus 200 conducts processing at step 904 and subsequent steps shown in FIG. 9. Processing conducted at steps 904 to 908 shown in FIG. 9 is equivalent to the processing conducted at the steps 603 to 607 and described in the first embodiment. If the user has not ordered the manipulation termination at the step 907, then the input apparatus 200 returns to the step 901 and continues the processing.

Details of the operation conducted when the decision at the step 902 is “Yes” in the processing flow described earlier will now be described with reference to FIG. 8. For example, if coordinates of three latest points on which the cursor 104 has moved are coordinates (x3,y3), coordinates (x4,y4) and coordinates (x5,y5), then center coordinates (Xc,Yc) of a circle which passes through the coordinates of the three points of the cursor 104 become the coordinates of the center coordinates 802 shown in FIG. 8.

In this case, the movement of the cursor 104 is supposed to be a manipulation of the large locus 800. In the user's next manipulation, therefore, the wheel becomes unrotated unless the cursor is not moved largely. This results in a problem that it becomes difficult for the user to grasp the manipulation state.

Also in the case where the user is about to conduct an operation different from the circle operation such as, for example, a rectilinear operation or manipulation, the locus of the cursor 104 assumes a state similar to the example shown in FIG. 8. Thus, a problem that a manipulation which is not intended to be a circle manipulation by the user is recognized as a circle manipulation is also posed.

In the present embodiment, these problems are coped with as follows. When the center coordinates 802 are at least a predetermined distance from the center coordinates 105 of a circle operation, as in, for example, the case where the center coordinates 802 has got out of a range of coordinates which can be manipulated by the user in FIG. 8, the center coordinates 802 are not used as values of center coordinates 105 of a new circle operation.

As a result, it becomes possible for the user to input a suitable circle manipulation to the input apparatus 200.

Thus, in the input apparatus 200 according to the present embodiment, the user can select an arbitrary item included in the selection item 101 by conducting a manipulation via the input unit 201 formed of a pointing device and thereby conducting a manipulation to move the cursor 104 so as to draw a circle. No matter which coordinates on the display unit 100 the cursor 104 is located in, the user can conduct the above-described manipulation. And the input apparatus 200 implements the above-described manipulation by using a method which is light in the load of computation processing described below. On the basis of coordinates of the latest three points on which the cursor 104 has moved, the input apparatus 200 calculates center coordinates of a circle which passes through the coordinates. On the basis of assumption that the center coordinates are the center coordinates 105 of the circle operation, the input apparatus 200 calculates the rotation angle of the cursor 104.

In addition, if the center coordinates of the circle which passes through the latest coordinates of the three points are at least a predetermined distance from the coordinates of the center coordinates 105 of the latest circle operation, then the coordinates of the center coordinates 105 of the circle operation are not updated. If the user has temporarily and greatly diverted a locus which draws a circle without intention, or the user has conducted a manipulation without the intention of a circle manipulation, therefore, then the manipulation is prevented from being reflected to the GUI such as the wheel 102.

As a result, the user can conduct manipulation intuitively in association with the display of the GUI. In addition, since the user receives real time feedback for the manipulation from the GUI, the user can understand the user's manipulation state easily.

Furthermore, since manipulations are conducted according to a circle motion, manipulations such as the menu item selection can be conducted continuously and smoothly.

It should be further understood by those skilled in the art that although the foregoing description has been made on embodiments of the invention, the invention is not limited thereto and various changes and modifications may be made without departing from the spirit of the invention and the scope of the appended claims.

1. A manipulation method performed by a computer comprising the steps of:
inputting specific coordinates on a screen pointed by a user using an input device;
displaying a graphical user interface on a screen of a display device;
displaying selection item having a form which allows the user to select an arbitrary item from among a plurality of items on the graphical user interface; and
determining center coordinates of a circle locus of the manipulation, when the user conducts a manipulation to move a location of coordinates pointed by the user on the screen so as to draw a circle, and rotating the selection item so as to be associated with a rotation angle of the manipulation with respect to the center coordinates.

2. The manipulation method according to claim 1, wherein when determining the center coordinates of the circle locus, an average location of coordinates pointed by the user on the screen over a definite time period is regarded as the center coordinates.

3. The manipulation method according to claim 2, wherein when determining the center coordinates of the circle locus, the center coordinates are disposed in a place which is a predetermined distance from the average location of coordinates pointed by the user on the screen over a definite time period, provided that coordinates pointed by the user on the screen are located at the same coordinates over a definite time period.

4. The manipulation method according to claim 1, wherein when determining the center coordinates of the circle locus, coordinates pointed by the user on the screen are acquired at intervals of a definite time period and a center of a circle which passes through coordinates of three latest points is regarded as the center coordinates.

5. The manipulation method according to claim 1, wherein if the center of the circle which passes through the coordinates of the three latest points is at least a definite distance from the previously calculated location of the center coordinates, then the center coordinates are not replaced by coordinates of the center of the circle which passes through the coordinates of the three latest points.
